(19) United States
(12) Patent Application Publication
(10) Pub. No.: US 2025/0389902 A1
(43) Pub. Date: Dec. 25, 2025

(54) ADJUSTABLE TIP FOR OPTICAL FIBER INSPECTION DEVICE

(71) Applicant: VIAVI Solutions Inc., Chandler, AZ (US)

(72) Inventors: Kevin CASSADY, Monroe, WA (US); Peter KRIOFSKE, Seattle, WA (US)

(21) Appl. No.: 18/749,303

(22) Filed: Jun. 20, 2024

(51) Int. Cl. G02B 6/38

(52) U.S. Cl. CPC G02B 6/385; G02B 6/3825

(57) ABSTRACT

A tip for an optical fiber inspection device includes an adjustable component that is configured to be selectively positioned in a plurality of positions to allow the adjustable component to be connected to a support component. An orientation axis of the adjustable component, when the adjustable component is in a first position, has a first angle with respect to a longitudinal axis of the support component, and the orientation axis of the adjustable component, when the adjustable component is in a second position, has a second angle with respect to the longitudinal axis of the support component that is different than the first angle. The tip can further include one or more position sensors to identify a position, of the plurality of positions, of the adjustable component, and provide a signal indicating the position of the adjustable component to the optical fiber inspection device.

### BACKGROUND

An optical cable may include one or more optical fibers. The one or more optical fibers typically terminate at an end of the optical cable, such that respective end faces of the optical fibers are exposed. In many cases, the end faces should be free from dirt particles, dust particles, scratches, and/or other surface defects to ensure an optimal optical connection when the optical cable is connected to another optical cable or another optical device.

### SUMMARY

In some implementations, a tip for an optical fiber inspection device includes an adjustable component to interface with at least one of an optical connector of an optical cable or a bulkhead adapter attached to the optical connector; and a support component configured to provide structural support to the adjustable component, wherein the adjustable component is configured to be selectively positioned in a plurality of positions to allow the adjustable component to be connected to the support component, wherein: an orientation axis of the adjustable component, when the adjustable component is in a first position, of the plurality of positions, has a first angle with respect to a longitudinal axis of the support component, and the orientation axis of the adjustable component, when the adjustable component is in a second position, of the plurality of positions, has a second angle with respect to the longitudinal axis of the support component that is different than the first angle.

In some implementations, a tip for an optical fiber inspection device includes an adjustable component; a support component; and one or more position sensors, wherein the adjustable component is configured to be selectively positioned in a plurality of positions to allow the adjustable component to be connected to the support component, and wherein the one or more position sensors are configured to: identify a position, of the plurality of positions, of the adjustable component, and provide a signal indicating the position of the adjustable component to the optical fiber inspection device.

In some implementations, an optical assembly includes an adjustable component configured to be selectively positioned in a plurality of positions to allow the adjustable component to be connected to a support component of the optical assembly, wherein: an orientation axis of the adjustable component, when the adjustable component is in a first position, of the plurality of positions, has a first angle with respect to a longitudinal axis of the support component, and the orientation axis of the adjustable component, when the adjustable component is in a second position, of the plurality of positions, has a second angle with respect to the longitudinal axis of the support component that is different than the first angle.

### BRIEF DESCRIPTION OF THE DRAWINGS

FIGS. 1A-1D are diagrams of one or more example implementations described herein.

FIGS. 2A-2B are diagrams of one or more example implementations described herein.

FIGS. 3A-3C are diagrams of one or more example implementations described herein.

FIGS. 4A-4B are diagrams of one or more example implementations described herein.

FIG. 5 is a diagram of example components of a device.

### DETAILED DESCRIPTION

The following detailed description of example implementations refers to the accompanying drawings. The same reference numbers in different drawings may identify the same or similar elements. The techniques, principles, procedures, and methods described herein may be used with any sensor implemented in a device having a tip that interfaces with an object or medium to be analyzed, including but not limited to other optical sensors and spectral sensors.

A technician may use a device, such as a handheld optical fiber microscope, to inspect an end face of an optical fiber of an optical cable prior to connecting the optical cable to network equipment. The device may include a light source to illuminate the end face of the optical fiber and an image sensor to capture images, live video, and/or the like, of an end face of the optical fiber so that the device (and/or another device) may analyze the images for dirt particles, dust particles, scratches, and/or other surface defects.

In some cases, an inspection tip may be designed to interface with an end face of an optical fiber having a particular type and/or configuration. That is, for example, a first inspection tip may have a first inspection tip type and a second inspection tip may have a second inspection tip type. The first inspection tip type may be designed for interfacing and/or inspecting an optical fiber having a first optical fiber type, and the second inspection tip type may be designed for interfacing and/or inspecting an optical fiber having a second optical fiber type. “Optical fiber type” refers to one or more characteristics of the optical fiber and/or the end face of the optical fiber, such as whether the end face is flat or angled. However, having to switch between multiple inspection tips can be cumbersome and time-consuming, and keeping track of the inspection tips requires storage and organization. Further, a likelihood of misplacing or losing an inspection tip is high, which can result in an inability of the device to inspect optical fibers of a an optical fiber type that corresponds to an inspection tip type of the misplaced or lost inspection tip.

Further, in some cases, to facilitate accurate measurements, the device (e.g., the handheld optical fiber microscope) can be configured in association with the inspection tip type of the inspection tip that is used. Configuration of the device may include manually adjusting any number of parameters based on the inspection tip type. The parameters may include, for example, a sampling rate, a magnification, a mirror position, a mirror orientation, an exposure time (associated with an imaging device), and/or a processing algorithm, among other examples. However, to make the adjustments, the user of the device must have information indicating the particular adjustments to be made, and must spend time making the adjustments, which may lead to inefficient operation of the device.

Some implementations described herein include a tip, such as a tip for a device (e.g., an optical fiber inspection device, such as an optical fiber microscope). The tip includes a support component and an adjustable component. The adjustable component can interface with at least one of an optical connector of an optical cable or a bulkhead adapter attached to the optical connector. The support component provides structural support to the adjustable component.

The adjustable component can be selectively positioned in a plurality of positions (e.g., to allow the adjustable component to be connected to the support component). When the adjustable component is in a first position, an orientation axis of the adjustable component has a first angle with respect to a longitudinal axis of the support component, and when the adjustable component is in a second position, an orientation axis of the adjustable component has a second angle (e.g., that is different than the first angle) with respect to the longitudinal axis of the support component. The adjustable component can be adjusted by, for example, rotation of the adjustable component within a recess of the support component or removal of the adjustable component from the recess of the support component and then reinsertion of the adjustable component into the recess of the support component.

In this way, a longitudinal axis of the support component can be aligned with a normal axis of an end face of an optical fiber of the optical cable, regardless of whether the end face is angled, when the adjustable component interfaces with the optical connector and/or the bulkhead adapter. For example, when the end face of the optical fiber has a flat surface, the adjustable component can be in a first position (e.g., where an orientation axis of the adjustable component has a zero degree angle with respect to the longitudinal axis of the support component), which allows the longitudinal axis of the support component to have a zero degree angle with respect to the normal axis of the end face of the optical fiber. As another example, when the end face of the optical fiber has an angled surface (e.g., a non-zero degree angle, such as θ degrees), the adjustable component can be in a second position (e.g., where an orientation axis of the adjustable component has a non-zero degree angle, such as θ degrees, with respect to the longitudinal axis of the support component), which allows the longitudinal axis of the support component to have a zero degree angle with respect to the normal axis of the end face of the optical fiber.

Accordingly, the adjustable component can be positioned to allow light (e.g., that originates from a light source of the device), which propagates through the tip and impinges on the end face of the optical fiber along the normal axis of the end face, to reflect back through the tip along the longitudinal axis of the support component (e.g., to the device). This enables the light to reach the device (e.g., as opposed to being reflected into a sidewall of the tip), and thereby facilitates inspection of the end face by the device.

Thus, in some implementations, a single tip can be used to inspect multiple different optical fiber types (e.g., with differently angled end faces). This reduces a need to store and organize multiple tips and reduces a likelihood of misplacing or losing a tip. Therefore, a likelihood that the device is unable to inspect optical fibers of a particular optical fiber type is minimized. Further, because the tip is easily adjustable between many different positions, the device can more efficiently switch between inspecting optical fibers of different optical fiber types.

Additionally, the tip may include one or more position sensors to identify a position of the adjustable component and to provide a signal indicating the position of the adjustable component to the device. The device may configure, based on the signal indicating the position of the adjustable component, at least one parameter associated with inspecting the end face of the optical fiber.

In this way, the tip enables a technician or other user to quickly and easily adjust the adjustable component for inspecting optical fibers having different types and/or characteristics without dependence on an external source of information associated with the tip configuration and/or without the need for manual configuration by the technician or user. This enables efficient configuration of the tip for use with different optical fibers. In this way, time for switching between a configuration for inspecting an optical fiber of one type and a configuration for inspecting an optical fiber of another type may be reduced. This may improve a throughput of a technician with regard to a quantity of optical cables (of potentially different configurations) that the technician can inspect within a period of time, and/or the like.

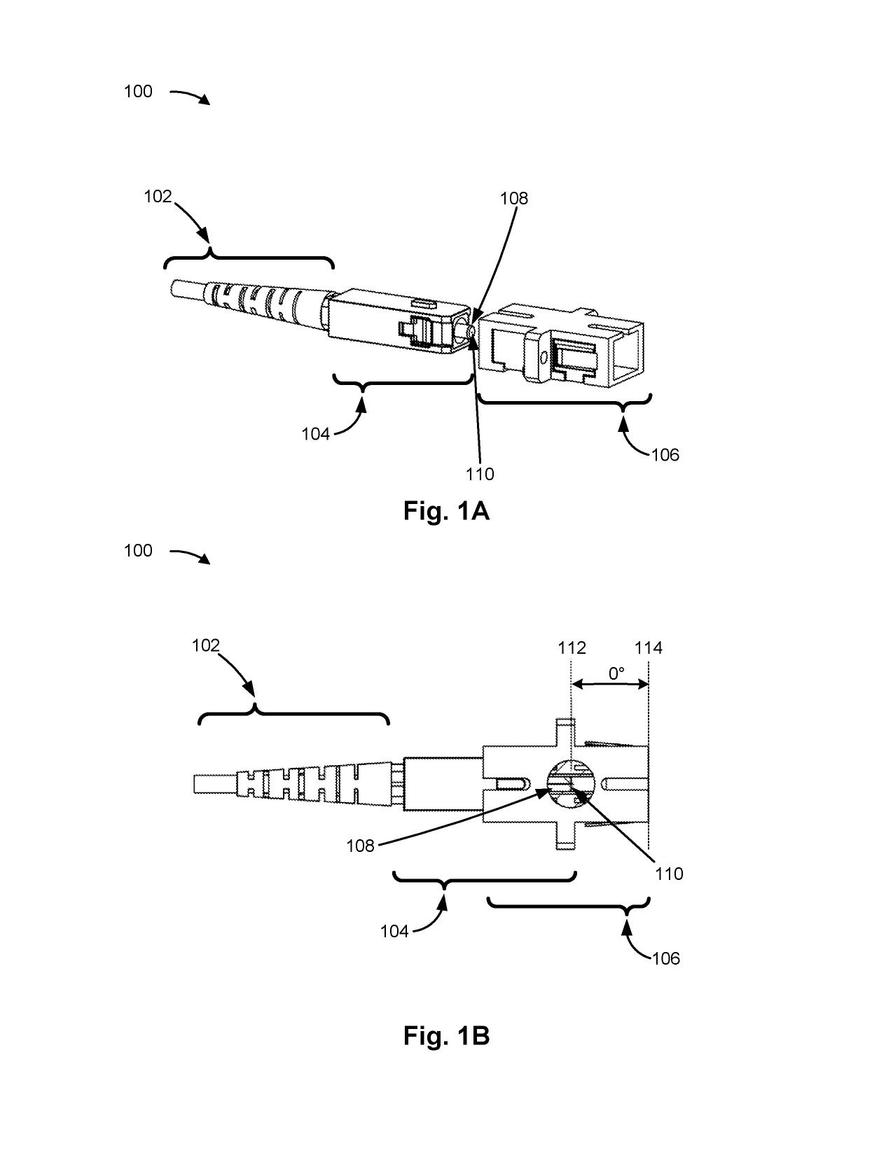

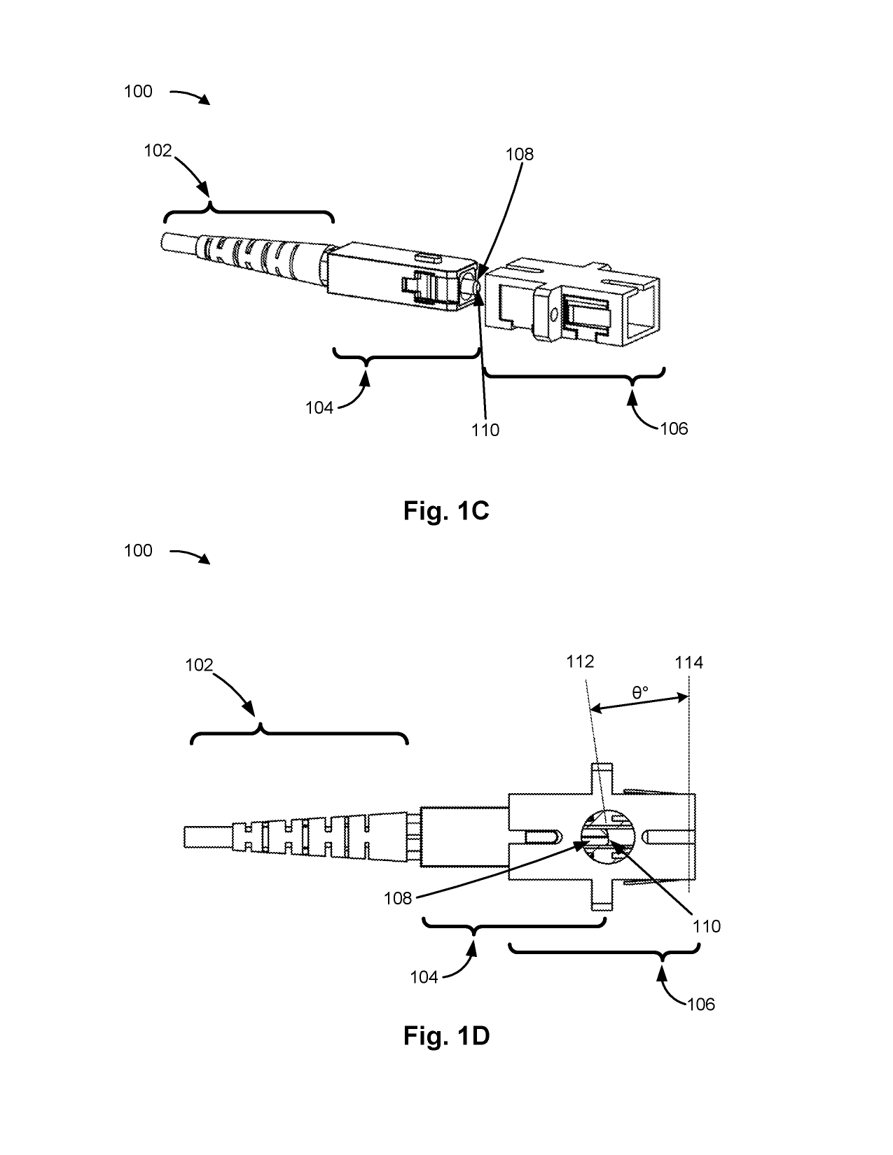

FIGS. 1A-1D are diagrams of one or more example implementations 100 described herein. As shown in FIGS. 1A-1D, example implementation(s) 100 may include an optical cable 102, an optical connector 104, and a bulkhead adapter 106. FIG. 1A shows an angled, exploded, side view of a first configuration of the optical cable 102, the optical connector 104, and the bulkhead adapter 106; FIG. 1B shows a side, cut-out view of the first configuration when the optical cable 102 and the optical connector 104 are connected to the bulkhead adapter 106; FIG. 1C shows an angled, exploded, side view of a second configuration of the optical cable 102, the optical connector 104, and the bulkhead adapter 106; and FIG. 1D shows a side, cut-out view of the second configuration when the optical cable 102 and the optical connector 104 are connected to the bulkhead adapter 106.

The optical cable 102 may include one or more optical fibers 108. For example, an optical fiber 108 may be disposed within a central region of the optical cable 102, along a length of the optical cable 102. As another example, the optical cable 102 may include a plurality of optical fibers 108 arranged in an optical fiber package that is disposed within the central region of the optical cable 102, along the length of the optical cable 102. The plurality of optical fibers 108 may be arranged, for example, in a one-dimensional array or a two-dimensional array within the optical fiber package (e.g., in a cross-section view of the optical fiber package). In some implementations, the optical cable 102 may include a ferrule comprising metal, ceramic, high-quality plastic, and/or the like, and the ferrule may have a hollowed-out center that holds and/or grips the one or more optical fibers 108.

The optical connector 104 may be attached to the optical cable 102. The optical connector 104 may include any fiber optic connector that includes an optical fiber 108, such as a fiber-optic connector (FC), an FC/physical content (PC) connector, an FC/angled physical content (APC) connector, a snap-in connector (SC), a straight tip (ST) connector, and/or a small-form factor (LC) connector, among other examples.

The one or more optical fibers 108 of the optical cable 102 may extend from an end of the optical cable 102 and into the optical connector 104. For example, each optical fiber 108 may extend into and terminate within the optical connector 104, with an end face 110 that is exposed within the optical connector 104. As shown in FIGS. 1A-1B, the end face 110 may have a “flat” surface (e.g., a surface axis 112 of the end face 110 has a zero (0) degree angle with respect to a latitudinal axis 114 of optical connector 104). For example, the end face 110 may be polished to have an angle of zero degrees (e.g., within a tolerance of 1 degree) with respect to the latitudinal axis 114. Alternatively, as shown in FIGS. 1C-1D, the end face 110 may have an angled surface (e.g., a non-zero angle with respect to the latitudinal axis 114 of the optical connector 104). For example, the end face 110 may be polished at a precise angle, such as θ degrees (e.g., within a tolerance of 1 degree), which may be 8 degrees in some implementations, with respect to the latitudinal axis 114.

In some implementations, each optical fiber may be mounted in an interstitial material within the optical connector 104 (e.g., when the optical connector 104 is connected to the optical cable 102). Furthermore, the optical connector 104 may include a connector body, which may comprise metal or plastic, and the connector body may provide a structure to hold the ferrule of the optical cable 102 and/or attach to a jacket of the optical cable 102.

The bulkhead adapter 106 may be attached to the optical connector 104. The bulkhead adapter 106 may facilitate connection between the optical cable 102 (and/or the optical connector 104) and another optical cable (and/or another optical connector). In some implementations, the optical connector 104 may further include a coupling mechanism that is used to hold the optical connector 104 in place when attached to the bulkhead adapter 106. Accordingly, the bulkhead adapter 106 may have a geometry that is designed to mate with the coupling mechanism of the optical connector 104, whereby physical characteristics of the bulkhead adapter 106 (e.g., shape, size, and/or pattern) may vary depending on the type of the optical connector 104 to be attached to the bulkhead adapter 106. The bulkhead adapter 106 may include an adapter body, which may comprise metal or plastic.

As indicated above, FIGS. 1A-1D are provided as one or more examples. Other examples may differ from what is described with regard to FIGS. 1A-1D. In practice, there may be additional components, fewer components, different components, or differently arranged components than those shown in FIGS. 1A-1D.

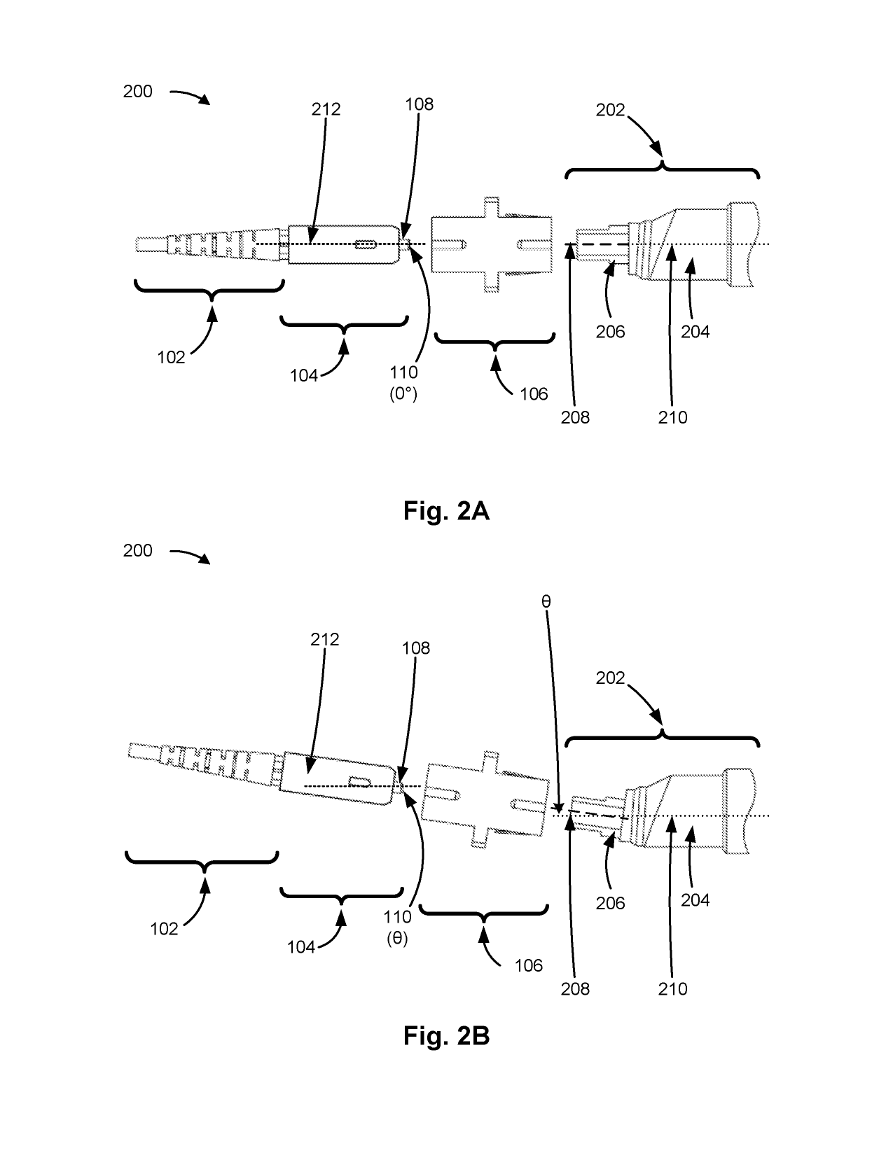

FIGS. 2A-2B are diagrams of one or more example implementations 200 described herein. As shown in FIGS. 2A-2B, example implementation(s) 200 may include the optical cable 102, the optical connector 104, the bulkhead adapter 106, and a tip 202. FIG. 2A shows an exploded, side view of the optical cable 102, the optical connector 104, the bulkhead adapter 106, and the tip 202 when the tip 202 is adjusted to a first orientation configuration (e.g., a zero degree angle configuration); and FIG. 2B shows an exploded, side view of the optical cable 102, the optical connector 104, the bulkhead adapter 106, and the tip 202 when the tip 202 is adjusted to a second orientation configuration (e.g., a non-zero degree angle position, shown as a θ degree angle configuration).

The tip 202 may be a tip (e.g., an inspection tip) for an optical fiber inspection device (not shown). The optical fiber inspection device may include one or more components to capture and/or analyze an image or video of an end face 110 of an optical fiber 108, of one or more optical fibers 108 included in the optical cable 102, when the optical connector 104 is connected to the optical cable 102 and/or when the bulkhead adapter 106 is attached to the optical connector 104. For example, the optical fiber inspection device may include (e.g., housed within the optical fiber inspection device) one or more optical components, such as a lens, a light source (e.g., a light emitting diode (LED), or another type of light source), and a sensor (e.g., an image sensor, a video sensor, and/or another type of sensor), and/or one or more other components.

The tip 202 may be an optical assembly that is configured to attach to the optical fiber inspection device (e.g., to an end of the optical fiber inspection device, such as an end of the optical fiber inspection device associated with the lens described above). In some implementations, the tip 202 may be an independent component (e.g., that is not included in the optical fiber inspection device) and may be configured to attach to the optical fiber inspection device (e.g., the end of the optical fiber inspection device). Alternatively, the tip 202 may be an integrated component of the optical fiber inspection device, such that the tip 202 and the optical fiber inspection device form a unified structure. Accordingly, in some implementations, the tip 202 may be a component of the optical fiber inspection device.

As further shown in FIGS. 2A-2B, the tip 202 may include a support component 204 and an adjustable component 206. The support component 204 may be configured to provide structural support to the adjustable component 206. For example, the support component 204 may be configured to hold the adjustable component 206 (e.g., within a recess, socket, or other holding portion of the support component 204). Additionally, the support component 204 may be configured to attach the tip 202 to the optical fiber inspection device. For example, the support component 204 may be configured to attach to (e.g., screw on or clip to, among other examples) the optical fiber inspection device (e.g., the end of the optical fiber inspection device), or otherwise interface with the optical fiber inspection device. Accordingly, the support component 204 may comprise metal or plastic or another strong and/or durable material.

The adjustable component 206 may be configured to connect to the support component 204 (e.g., to be held by the support component 204). For example, an end of the adjustable component 206 may be configured to be inserted into, and held by, a recess, socket, or other holding portion of the support component 204. The adjustable component 206 may be further configured to interface with at least one of the optical connector 104 or the bulkhead adapter 106 (e.g., to facilitate the optical fiber inspection device capturing an image and/or video of an end face 110 of an optical fiber 108 of the optical cable 102). That is, the adjustable component 206 may be an interface component that is configured to insert into the bulkhead adapter 106 and to contact respective interior surfaces of the optical connector 104 and/or the bulkhead adapter 106. Accordingly, the adjustable component 206 may comprise metal or plastic or another strong and/or durable material.

As further shown in FIGS. 2A-2B the adjustable component 206 may be configured to be selectively positioned in a plurality of positions to allow the adjustable component 206 to be connected to the support component 204. In this way, the adjustable component 206 may be adjustable in a manner that allows an angle of an orientation axis 208 of the adjustable component 206 with respect to a longitudinal axis 210 of the support component 204 to change. For example, as shown in FIG. 2A, when the adjustable component 206 is in a first position, of a plurality of positions, the orientation axis 208 of the adjustable component 206 has a first angle with respect to the longitudinal axis 210 of the support component 204. The first angle may be, for example, a zero degree angle (e.g., within a tolerance of 1 degree). Additionally, as shown in FIG. 2B, when the adjustable component 206 is in a second position, of the plurality of positions, the orientation axis 208 of the adjustable component 206 has a second angle with respect to the longitudinal axis 210 of the support component 204. The second angle may be, for example, a non-zero degree angle (shown as θ degrees), such as 8 degrees (e.g., within a tolerance of 1 degree).

Accordingly, in either position, the longitudinal axis 210 of the support component 204 may be aligned with (e.g., parallel to, such as within a tolerance of 1 degree) a normal axis 212 of the end face 110 of the optical fiber 108 (e.g., when the adjustable component 206 interfaces with at least one of the optical connector 104 or the bulkhead adapter 106). That is, the longitudinal axis 210 of the support component 204 may have a zero degree angle (e.g., within a tolerance of 1 degree) with respect to the normal axis 212. For example, as shown in FIG. 2A, when an end face 110 of an optical fiber 108 has a flat surface (e.g., as described herein in relation to FIGS. 1A-1B), the longitudinal axis 210 of the support component 204 may have an angle of zero degrees (e.g., within a tolerance of 1 degree) with respect to the normal axis 212 of the end face 110 of the optical fiber 108. As another example, as shown in FIG. 2B, when an end face 110 of an optical fiber 108 has an angled surface (e.g., a non-zero degree angle, such as θ degrees, with respect to the latitudinal axis 114 of the optical connector 104, as described herein in relation to FIGS. 1C-1D), the longitudinal axis 210 of the support component 204 may have an angle of zero degrees (e.g., within a tolerance of 1 degree) with respect to the normal axis 212 of the end face 110 of the optical fiber 108. In such cases, the orientation axis 208 may have an angle of θ degrees (e.g., within a tolerance of 1 degree) with respect to the longitudinal axis 210 of the support component 204 and with respect to the normal axis 212.

In this way, regardless of the angle of the end face 110 of the optical fiber 108, the adjustable component 206 may be positioned to allow light (e.g., that originates from the light source of the optical fiber inspection device) that impinges on the end face 110 of the optical fiber 108 along the normal axis 212 to reflect back through the tip 202 along the longitudinal axis 210 of the support component 204 (e.g., to the optical fiber inspection device). This enables the light to reach the optical fiber inspection device (e.g., as opposed to being reflected into a sidewall of the tip 202).

In some implementations, the adjustable component 206 may be configured to be selectively positioned in a plurality of positions (e.g., a plurality of different positions that allow the adjustable component 206 to be connected to the support component 204). For example, the orientation axis 208 of the adjustable component 206, when the adjustable component 206 is in a first position, of the plurality of positions, has a first angle with respect to a longitudinal axis 210 of the support component 204; the orientation axis 208 of the adjustable component 206, when the adjustable component 206 is in a second position, of the plurality of positions, has a second angle with respect to a longitudinal axis 210 of the support component 204; and so on. The first angle, the second angle, and so on, may be different from each other.

In some implementations, the adjustable component 206 may be configured to be in a particular position, of the plurality of positions, to allow the orientation axis 208 of the adjustable component 206 to have a particular angle with respect to the longitudinal axis 210 of the support component 204. The particular angle may be within an angle range (e.g., that is from a minimum angle supported by the adjustable component 206 to a maximum angle supported by the adjustable component 206). The angle range may be, for example, from 0 degrees to 8 degrees (e.g., greater than or equal to 0 degrees and less than or equal to 8 degrees).

In some implementations, when the adjustable component 206 is in a first position, of the plurality of positions, the orientation axis 208 of the adjustable component 206 may have a first angle that is equal to a minimum angle, of the angle range, with respect to the longitudinal axis 210 of the support component 204; when the adjustable component 206 is in a second position of the plurality of positions, the orientation axis 208 of the adjustable component 206 may have a second angle that is equal to a maximum angle, of the angle range, with respect to the longitudinal axis 210 of the support component 204. Additionally, when the adjustable component 206 is in a third position of the plurality of positions, the orientation axis 208 of the adjustable component 206 may have a third angle with respect to the longitudinal axis 210 of the support component 204 that is within the angle range. Accordingly, the third angle may be greater than the first angle (e.g., the minimum angle) and less than the second angle (e.g., the maximum angle).

In some implementations, an angle of the orientation axis 208 of the adjustable component 206 with respect to the longitudinal axis 210 of the support component 204 is equal to (e.g., within a tolerance of 1 degree) an angle of a surface axis 112 of an end face 110 of an optical fiber 108 of the optical cable 102 with respect to a latitudinal axis 114 of the optical connector 104. Accordingly, when the angle of the surface axis 112 of the end face 110 of the optical fiber 108 of the optical cable 102 with respect to a latitudinal axis 114 of the optical connector 104 is θ degrees, the angle of the orientation axis 208 of the adjustable component 206 with respect to the longitudinal axis 210 of the support component 204 may also be θ degrees. In a specific example, when the angle of the surface axis 112 of the end face 110 of the optical fiber 108 of the optical cable 102 with respect to a latitudinal axis 114 of the optical connector 104 is 8 degrees, the angle of the orientation axis 208 of the adjustable component 206 with respect to the longitudinal axis 210 of the support component 204 may also be 8 degrees. Further description related to the tip 202 is provided herein.

As indicated above, FIGS. 2A-2B are provided as one or more examples. Other examples may differ from what is described with regard to FIGS. 2A-2B. In practice, there may be additional components, fewer components, different components, or differently arranged components than those shown in FIGS. 2A-2B.

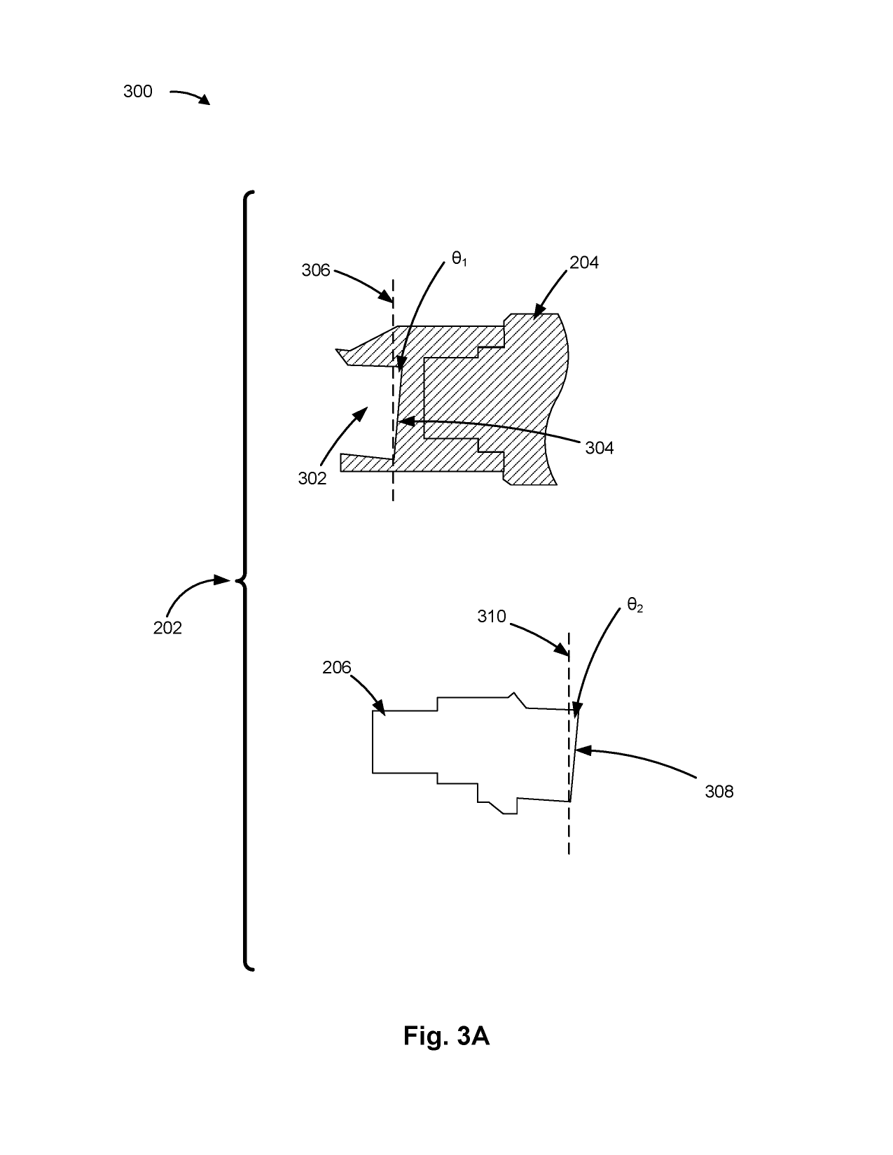

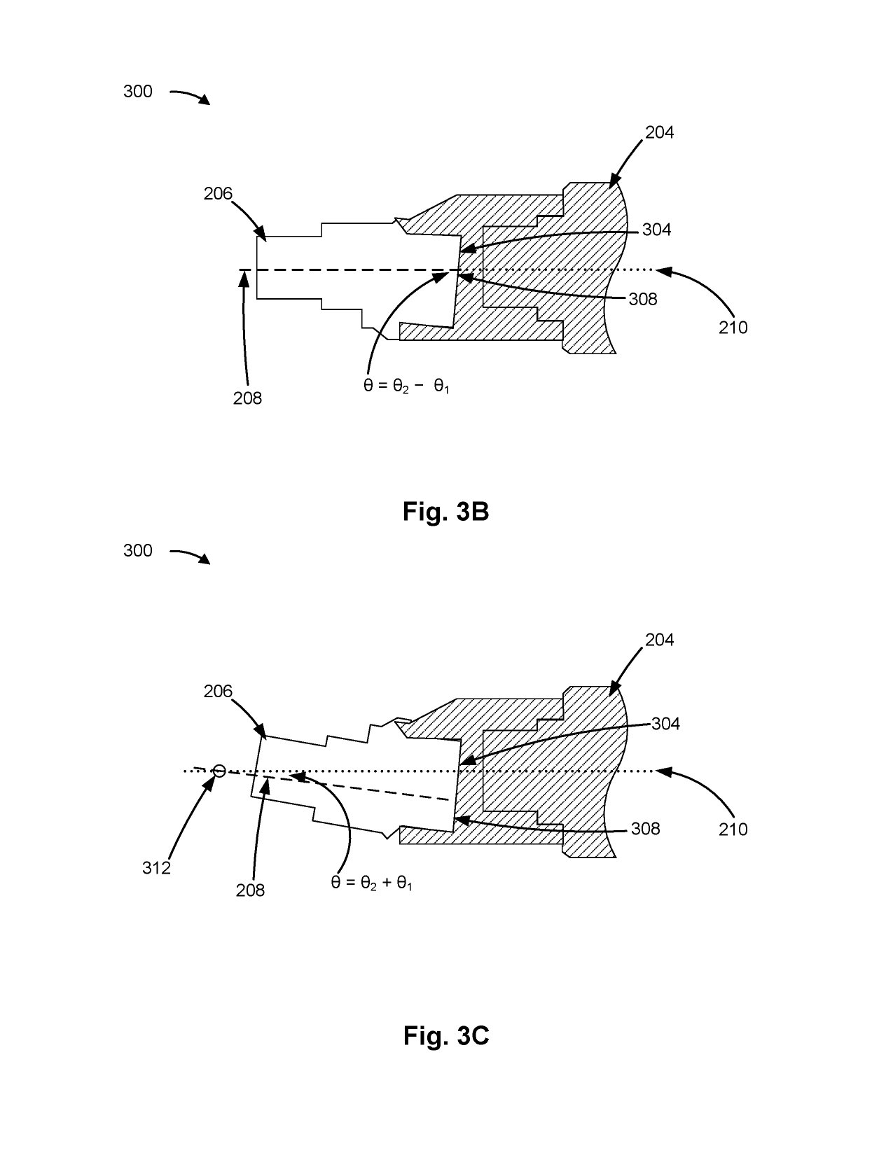

FIGS. 3A-3C are diagrams of one or more example implementations 300 described herein. As shown in FIGS. 3A-3B, example implementation(s) 300 may include the support component 204 and the adjustable component 206 of the tip 202. FIG. 3A shows a component view of the tip 202; FIG. 3B shows a side view of the tip 202 in a first orientation configuration (e.g., the zero degree angle configuration) when the adjustable component 206 is adjusted to a first position and held by the support component 204; and FIG. 3C shows a side view of the tip 202 in a second orientation configuration (e.g., the non-zero degree angle configuration) when the adjustable component 206 is adjusted to the second position and held by the support component 204.

As shown in FIGS. 3A-3B, the support component 204 may include a recess 302. The recess 302 may be configured to hold the adjustable component 206 (e.g., within the recess 302). As shown in FIGS. 3A-3B, the recess 302 may have a recess surface 304. The recess surface 304 may be angled (e.g., an angled recess surface). For example, the recess surface 304 (e.g., a direction in which an edge of the recess surface 304 runs) may have an angle with respect to a latitudinal axis 306 of the support component 204, shown as θ₁ (also referred to as a third angle herein).

As further shown in FIGS. 3A-3B, the adjustable component 206 may include an end 308 that is configured to be inserted into the recess 302 of the support component 204, such as to allow the support component 204 to hold the adjustable component 206 and thereby provide structural support to the adjustable component 206. The end 308 may be angled. For example, the end 308 (e.g., a direction in which an edge of the end 308 runs) may have an angle with respect to a latitudinal axis 310 of the adjustable component 206, shown as θ₂ (also referred to as a fourth angle herein).

Each of the support component 204 and the adjustable component 206 may have an aperture, an opening, a hole, or other similar type of component that allows light to propagate, via the support component 204 and the adjustable component 206, between an end face 110 of an optical fiber 108 of an optical cable 102 and an optical fiber inspection device (e.g., a light source and/or a sensor of the optical inspection device).

In some implementations, as shown in FIG. 3B, when the adjustable component 206 is in a first position and is held by the support component 204 (e.g., the end 308 is inserted into the recess 302 of the support component 204), the angle of the orientation axis 208 of the adjustable component 206 with respect to the longitudinal axis 210 of the support component 204 may be expressed as θ = θ₂ − θ₁. Thus, in some implementations, θ₂ may equal θ₁, and therefore the angle of the orientation axis 208 of the adjustable component 206 with respect to the longitudinal axis 210 of the support component 204 may be a zero degree angle. Additionally, as shown in FIG. 3C, when the adjustable component 206 is in the second position and is held by the support component 204 (e.g., the end 308 is inserted into the recess 302 of the support component 204), the angle of the orientation axis 208 of the adjustable component 206 with respect to the longitudinal axis 210 of the support component 204 may be expressed as θ₂ + θ₁. Thus, in some implementations, θ₂ may equal θ₁, and therefore the angle of the orientation axis 208 of the adjustable component 206 with respect to the longitudinal axis 210 of the support component 204 may be a non-zero degree angle (e.g., 2 × θ₂ or 2 × θ₁).

Further, as shown in FIG. 3C, the longitudinal axis 210 of the support component 204 and the angle of the orientation axis 208 of the adjustable component 206 may converge at a point 312 external to the tip 202. Accordingly, the support component 204 and the adjustable component 206 may be designed such that, when the adjustable component 206 is in the second position and the adjustable component 206 interfaces with at least one of the optical connector 104 or the bulkhead adapter 106 (e.g., to facilitate the optical fiber inspection device inspecting the end face 110 of an optical fiber 108 of the optical cable 102), the end face 110 is to be positioned at the point 312. This may enable optimal imaging of the end face 110 by the optical fiber inspection device.

In some implementations, the adjustable component 206 may be adjusted from a first position to a second position, from a second position to a third position, and so on, by rotation of the adjustable component 206. That is, the adjustable component 206 may be rotated within the recess 302 of the support component 204 (e.g., without removing the adjustable component from the recess 302). In some implementations, the, adjustable component 206 may be rotated along the orientation axis 208. Accordingly, the adjustable component 206 may be configured to be selectively positioned in a plurality of positions by rotation of the adjustable component 206. Additionally, or alternatively, the adjustable component 206 may be adjusted by removal of the adjustable component 206 from the support component 204 and then by reinsertion of the adjustable component 206 into the support component 204. That is, the adjustable component 206 may be removed from the recess 302 of the support component 204 and then reinserted into the recess 302 (e.g., in a different position). Accordingly, the adjustable component 206 may be configured to be selectively positioned in a plurality of positions by removal of, and then reinsertion of, the adjustable component 206. While rotation of, and removal of and reinsertion of, the adjustable component 206 are discussed herein, some implementations include other ways to physically adjust the adjustable component 206 from one position to another position.

As indicated above, FIGS. 3A-3C are provided as one or more examples. Other examples may differ from what is described with regard to FIGS. 3A-3C. In practice, there may be additional components, fewer components, different components, or differently arranged components than those shown in FIGS. 3A-3C.

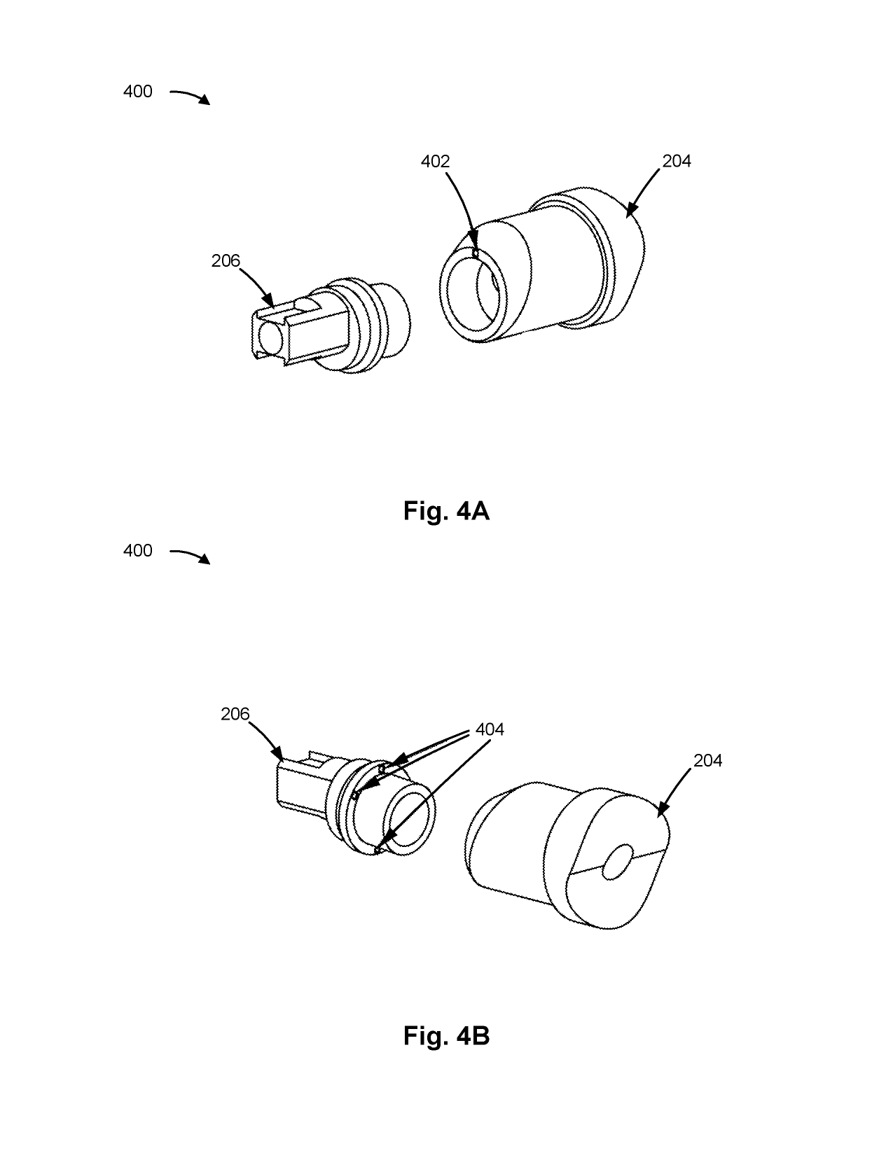

FIGS. 4A-4B are diagrams of one or more example implementations 400 described herein. As shown in FIGS. 4A-4B, example implementation(s) 400 may include the support component 204 and the adjustable component 206 of the tip 202. FIGS. 4A-4B show exploded, angled side views of example configurations of the tip 202.

The tip 202 may include one or more position sensors 402 and one or more position indicators 404. As shown in FIGS. 4A-4B, the support component 204 may include the one or more position sensors 402, and the adjustable component 206 may include the one or more position indicators 404. Each position indicator 404 may include a magnet, an indentation (e.g., an impression, a cut, a notch, a depression, a recess, or another type of indentation), a protrusion (e.g., a bump, a ridge, a tab, or another type of protrusion), a component with an electrical property (e.g., associated with resistance, capacitance, or continuity), an imprint (e.g., a printed feature comprising paint or ink, or another type of imprint), or another type of feature that can be detected by the one or more position sensors 402. Each position sensor 402 may include, for example, a magnetic sensor (e.g., to identify changes in magnetic fields), a mechanical sensor (e.g., to identify indentations and/or protrusions), an electrical sensor (e.g., to identify changes in electrical properties), an optical sensor (e.g., to identify different types of imprints), or another type of sensor.

Accordingly, the one or more position sensors 402 may be configured to identify a position of the adjustable component 206 (e.g., based on the one or more position indicators 404). For example, when the adjustable component 206 is in a first position (e.g., as shown in FIG. 3B), the one or more position sensors 402 may sense at least one particular position indicator 404 of the one or more position indicators 404, to thereby determine that the adjustable component 206 is in the first position. As another example, when the adjustable component 206 is in a second position (e.g., as shown in FIG. 3C), the one or more position sensors 402 may sense at least one other particular position indicator 404 of the one or more position indicators 404 to thereby determine that the adjustable component 206 is in the second position.

The one or more position sensors 402 may be configured to provide a signal indicating a position of the adjustable component 206. For example, when the one or more position sensors 402 determine that the adjustable component 206 is in the first position, the one or more position sensors 402 may provide a first signal indicating the first position; when the one or more position sensors 402 determine that the adjustable component 206 is in the second position, the one or more position sensors 402 may provide a second signal indicating the second position; and so on.

In some implementations, the one or more position sensors 402 may provide the signal indicating the position of the adjustable component 206 to the optical fiber inspection device (e.g., a configuration component of the optical fiber inspection device). The optical fiber inspection device (e.g., using the configuration component of the optical fiber inspection device) may configure, based on the signal indicating the position of the adjustable component 206, at least one parameter associated with inspecting an end face 110 of an optical fiber 108. For example, the signal indicating the position of the adjustable component 206 may activate software in the optical fiber inspection device that causes the optical fiber inspection device to initiate an inspection of the end face 110 of the optical fiber 108. Further, at least one inspection parameter implemented by the software in association with the inspection of the end face 110 of the optical fiber 108 may be based on the signal indicating the position of the adjustable component 206.

While FIGS. 4A-4B show the one or more position sensors 402 as being included in the support component 204 and the one or more position indicators 404 as being included in the adjustable component 206, other configurations may be used. For example, the one or more position sensors 402 may be included in the adjustable component 206 and the one or more position indicators 404 may be included in the support component 204. As another example, respective portions of the one or more position sensors 402 and the one or more position indicators 404 may be included in both the support component 204 and the adjustable component 206.

As indicated above, 4A-4B are provided as one or more examples. Other examples may differ from what is described with regard to FIGS. 4A-4B. In practice, there may be additional components, fewer components, different components, or differently arranged components than those shown in FIGS. 4A-4B.

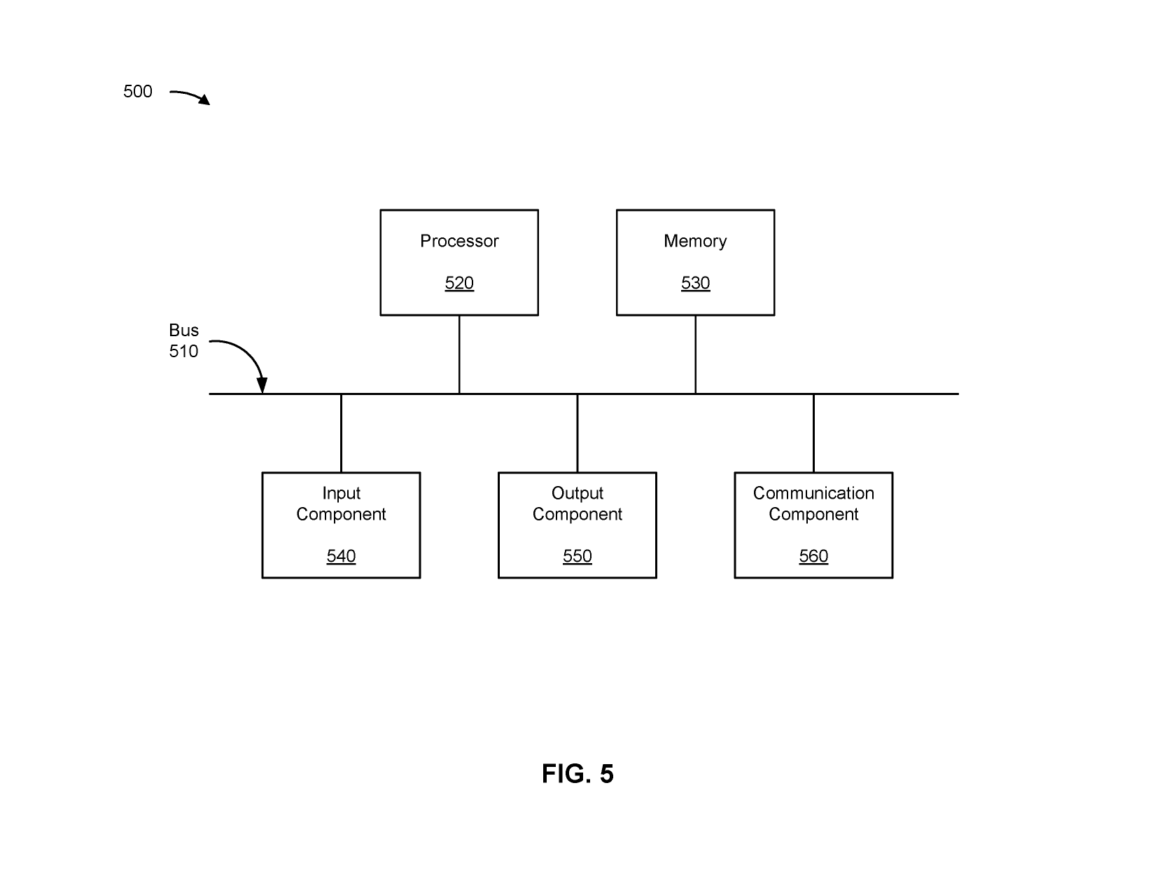

FIG. 5 is a diagram of example components of a device 500. The device 500 may correspond to the one or more position sensors 402 and/or the one or more position indicators 404. In some implementations, the one or more position sensors 402 and/or the one or more position indicators 404 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

The foregoing disclosure provides illustration and description, but is not intended to be exhaustive or to limit the implementations to the precise forms disclosed. Modifications and variations may be made in light of the above disclosure or may be acquired from practice of the implementations.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A tip for an optical fiber inspection device, comprising:
an adjustable component to interface with at least one of an optical connector of an optical cable or a bulkhead adapter attached to the optical connector; and
a support component configured to provide structural support to the adjustable component,
wherein the adjustable component is configured to be selectively positioned in a plurality of positions to allow the adjustable component to be connected to the support component, wherein:
an orientation axis of the adjustable component, when the adjustable component is in a first position, of the plurality of positions, has a first angle with respect to a longitudinal axis of the support component, and
the orientation axis of the adjustable component, when the adjustable component is in a second position, of the plurality of positions, has a second angle with respect to the longitudinal axis of the support component that is different than the first angle.

2. The tip of claim 1, wherein the adjustable component is further configured to be adjusted from the first position to the second position, and to be adjusted from the second position to the first position, by rotation of the adjustable component within a recess of the support component.

3. The tip of claim 1, wherein the adjustable component is further configured to be adjusted from the first position to the second position, and to be adjusted from the second position to the first position, by removal of the adjustable component from a recess of the support component and then by reinsertion of the adjustable component into the recess of the support component.

4. The tip of claim 1, wherein the first angle is associated with a minimum angle of an angle range and the second angle is associated with a maximum angle of the angle range, and
wherein the orientation axis of the adjustable component, when the adjustable component is in a third position, of the plurality of positions, has a third angle with respect to the longitudinal axis of the support component that is greater than the first angle and less than the second angle.

5. The tip of claim 1, wherein:
the first angle is a zero degree angle; and
the second angle is a non-zero degree angle.

6. The tip of claim 1, wherein:
the support component includes a recess that has a recess surface that has a third angle with respect to a latitudinal axis of the support component;
the adjustable component includes an end that is configured to be inserted into the recess of the support component to allow the support component to provide the structural support to the adjustable component; and
the end of the adjustable component has a fourth angle with respect to a latitudinal axis of the adjustable component.

7. The tip of claim 6, wherein the third angle is equal to the fourth angle.

8. The tip of claim 1, further comprising one or more position sensors and one or more position indicators.

9. The tip of claim 8, wherein the one or more position sensors are configured to:
identify a position, of the plurality of positions, of the adjustable component; and
provide a signal indicating the position of the adjustable component to the optical fiber inspection device.

10. A tip for an optical fiber inspection device, comprising:
an adjustable component;
a support component; and
one or more position sensors,
wherein the adjustable component is configured to be selectively positioned in a plurality of positions to allow the adjustable component to be connected to the support component, and
wherein the one or more position sensors are configured to:
identify a position, of the plurality of positions, of the adjustable component, and
provide a signal indicating the position of the adjustable component to the optical fiber inspection device.

11. The tip of claim 10, wherein:
an orientation axis of the adjustable component, when the adjustable component is in a first position, of the plurality of positions, has a first angle with respect to a longitudinal axis of the support component, and
the orientation axis of the adjustable component, when the adjustable component is in a second position, of the plurality of positions, has a second angle with respect to the longitudinal axis of the support component that is different than the first angle.

12. The tip of claim 11, wherein the adjustable component is configured to be adjusted from the first position to the second position, and to be adjusted from the second position to the first position, by at least one of:
rotation of the adjustable component; or
removal of the adjustable component from the support component and then reinsertion of the adjustable component into the support component.

13. The tip of claim 11, wherein:
the first angle is a zero degree angle; and
the second angle is a non-zero degree angle.

14. The tip of claim 10, wherein:
the support component includes a recess that has an angled recess surface; and
the adjustable component includes an angled end that is configured to be inserted into the recess of the support component.

15. An optical assembly, comprising:
an adjustable component configured to be selectively positioned in a plurality of positions to allow the adjustable component to be connected to a support component of the optical assembly, wherein:
an orientation axis of the adjustable component, when the adjustable component is in a first position, of the plurality of positions, has a first angle with respect to a longitudinal axis of the support component, and
the orientation axis of the adjustable component, when the adjustable component is in a second position, of the plurality of positions, has a second angle with respect to the longitudinal axis of the support component that is different than the first angle.

16. The optical assembly of claim 15, wherein the optical assembly is an independent component configured to attach to an optical fiber inspection device.

17. The optical assembly of claim 15, wherein the optical assembly is an integrated component of an optical fiber inspection device.

18. The optical assembly of claim 15, wherein the adjustable component is further configured to be adjusted from the first position to the second position, and to be adjusted from the second position to the first position, by at least one of:
rotation of the adjustable component; or
removal of the adjustable component from the support component and then reinsertion of the adjustable component into the support component.

19. The optical assembly of claim 15, wherein the adjustable component includes an angled end that is configured to be inserted into a recess of the support component that has an angled recess surface.

20. The optical assembly of claim 15, further comprising one or more position sensors configured to provide a signal indicating a position, of the plurality of positions, of the adjustable component.
